(19) United States
(12) Patent Application Publication
(10) Pub. No.: US 2023/0216218 A1
(43) Pub. Date: Jul. 6, 2023

(54) ONBOARD ANTENNA MODULE

(71) Applicants: AutoNetworks Technologies, Ltd., Yokkaichi-shi, Mie (JP); Sumitomo Wiring Systems, Ltd., Yokkaichi-shi, Mie (JP); Sumitomo Electric Industries, Ltd., Osaka-shi, Osaka (JP)

(72) Inventors: Yuji TAKENAKA, Yokkaichi-shi, Mie (JP); Shuhei TERADA, Yokkaichi-shi, Mie (JP); Ichiro KUWAYAMA, Osaka-shi, Osaka (JP); Suguru YAMAGISHI, Osaka-shi, Osaka (JP); Yutaro MIKI, Osaka-shi, Osaka (JP)

(21) Appl. No.: 18/000,548

(22) PCT Filed: May 26, 2021
(86) PCT No.: PCT/JP2021/019963

§ 371 Date: Dec. 2, 2022

(30) Foreign Application Priority Data
Jun. 4, 2020 (JP) 2020-097808

(51) Int. Cl. H01Q 21/28; H01Q 1/32

(52) U.S. Cl. CPC H01Q 21/28; H01Q 1/32

(57) ABSTRACT

An onboard antenna module includes: a plate-shaped member that is fixed to a body of a vehicle and at least a portion of which is plate-shaped; and a plurality of antennas that are provided on the plate-shaped member, wherein a plurality of antennas included in the plurality of antennas provided on the plate-shaped member constitute a first diversity antenna configured to receive RF (Radio Frequency) signals in a first frequency band, and at least two antennas included in the plurality of antennas that constitute the first diversity antenna are respectively provided in two regions that are not adjacent to each other when a flat surface of the plate-shaped member is divided into quadrants around a center point of the flat surface.

### CROSS-REFERENCE TO RELATED APPLICATIONS

This application is the U.S. national stage of PCT/JP2021/019963 filed on May 26, 2021, which claims priority of Japanese Patent Application No. JP 2020-097808 filed on Jun. 4, 2020, the contents of which are incorporated herein.

### TECHNICAL FIELD

The present disclosure relates to an onboard antenna module.

### BACKGROUND

JP 2009-224908A discloses the following digital terrestrial television receiving system. That is, the receiving system includes: one or two sets of antennas each including a first antenna and a second antenna that receive digital terrestrial television signals; a first amplifier that includes a first bandpass filter and a first amplifier circuit that are connected to the first antenna; a second amplifier that includes a second bandpass filter and a second amplifier circuit that are connected to the second antenna; and a combination processing means for combining signals that have undergone amplification processing performed by the first amplifier and the second amplifier. The first bandpass filter of the first amplifier has at least either a wider bandwidth characteristic or a gentler out-of-band attenuation characteristic compared to the second bandpass filter, and the first amplifier is an amplifier with high receiving sensitivity, whereas the second bandpass filter of the second amplifier has at least either a narrower bandwidth characteristic or a steeper out-of-band attenuation characteristic compared to the first bandpass filter, the second amplifier has a greater interference rejection capability than the first amplifier, the second amplifier circuit connected to the second bandpass filter is an amplifier circuit with a bypass switch or a gain-controlled amplifier circuit, and the second amplifier is an amplifier that has a high interference rejection property with a wider dynamic range than the first amplifier.

With the technique disclosed in JP 2009-224908A, it is not easy to precisely arrange each of the antennas included in the diversity antenna on the vehicle. For example, the distances between the antennas included in the diversity antenna may deviate from the designed values, which may make it difficult to receive RF signals with high sensitivity.

The present disclosure has been made to solve the above-described problem, and an object thereof is to provide an onboard antenna module capable of receiving RF signals with higher sensitivity.

### SUMMARY

An onboard antenna module according to the present disclosure includes: a plate-shaped member that is fixed to a body of a vehicle and at least a portion of which is plate-shaped; and a plurality of antennas that are provided on the plate-shaped member, wherein a plurality of antennas included in the plurality of antennas provided on the plate-shaped member constitute a first diversity antenna configured to receive RF (Radio Frequency) signals in a first frequency band, and at least two antennas included in the plurality of antennas that constitute the first diversity antenna are respectively provided in two regions that are not adjacent to each other when a flat surface of the plate-shaped member is divided into quadrants around a center point of the flat surface.

An onboard antenna module according to the present disclosure includes: a plate-shaped member that is fixed to a body of a vehicle and at least a portion of which is plate-shaped; and a plurality of antennas that are provided on the plate-shaped member, wherein the plurality of antennas are provided in an opening in a roof panel of a vehicle in a plan view, a plurality of antennas included in the plurality of antennas constitute a first diversity antenna configured to receive RF signals in a first frequency band, and at least two antennas included in the plurality of antennas that constitute the first diversity antenna are respectively provided in two regions that are not adjacent to each other when the opening is divided into quadrants around a center point of the opening in a plan view.

One aspect of the present disclosure can be realized not only as an onboard antenna module that includes such characteristic processing units, but also as a method for carrying out such characteristic processing as steps, or as a program for enabling a computer to execute such steps. Also, one aspect of the present disclosure can be realized as a semiconductor integrated circuit that realizes a part or the entirety of the onboard antenna module, or can be realized as a system that includes the onboard antenna module.

### Effects of the Present Disclosure

According to the present disclosure, RF signals can be received with higher sensitivity.

### BRIEF DESCRIPTION OF THE DRAWINGS

FIG. 1 is a schematic perspective view showing a vehicle according to an embodiment of the present disclosure.

FIG. 2 is a cross-sectional view showing a roof panel module according to an embodiment of the present disclosure.

FIG. 3 is an exploded perspective view showing the roof panel module according to the embodiment of the present disclosure.

FIG. 4 is a plan view showing an example of a configuration of the onboard antenna module according to the embodiment of the present disclosure.

FIG. 5 is a plan view showing another example of the configuration of the onboard antenna module according to the embodiment of the present disclosure.

FIG. 6 is a diagram showing an example of a configuration of the circuit unit according to the embodiment of the present disclosure.

FIG. 7 is a diagram showing the directivity of an antenna according to the embodiment of the present disclosure.

FIG. 8 is a graph showing the directivity of an antenna according to the embodiment of the present disclosure.

FIG. 9 is a graph showing the directivity of an antenna according to the embodiment of the present disclosure.

FIG. 10 is a graph showing the directivity of an antenna according to the embodiment of the present disclosure.

FIG. 11 is a flowchart that defines an example of an operating procedure that is performed when the circuit unit in the onboard antenna module according to the embodiment of the present disclosure selectively transmits an RF signal to an onboard device.

### DETAILED DESCRIPTION OF PREFERRED EMBODIMENTS

Conventionally, a receiving system that has a plurality of antennas and employs a diversity scheme has been proposed.

First, the details of an embodiment of the present disclosure are listed and described.

An onboard antenna module according to the present disclosure includes: a plate-shaped member that is fixed to a body of a vehicle and at least a portion of which is plate-shaped; and a plurality of antennas that are provided on the plate-shaped member, wherein a plurality of antennas included in the plurality of antennas provided on the plate-shaped member constitute a first diversity antenna configured to receive RF (Radio Frequency) signals in a first frequency band, and at least two antennas included in the plurality of antennas that constitute the first diversity antenna are respectively provided in two regions that are not adjacent to each other when a flat surface of the plate-shaped member is divided into quadrants around a center point of the flat surface.

As described above, with the structure in which the antennas that constitute the first diversity antenna are respectively provided in two regions that are not adjacent to each other when the flat surface of the plate-shaped member is divided into quadrants, a plurality of antennas including the antennas arranged at desired positions on the plate-shaped member in advance can be mounted on the vehicle all at once. Therefore, for example, compared to a case where the antennas are individually arranged on the vehicle, the antennas can be more precisely mounted on the vehicle so that the distance therebetween is as designed. Furthermore, the distance between the two antennas that constitute the first diversity antenna can be secured in a limited arrangement space on the plate-shaped member, and the degree of correlation between the two antennas can be lowered. Therefore, RF signals can be received with higher sensitivity.

Preferably, the two antennas included in the plurality of antennas that constitute the first diversity antenna are provided on the plate-shaped member so as to sandwich other antennas configured to receive RF signals in a frequency band that is higher than the first frequency band.

With such a configuration, antennas configured to receive RF signals in a high frequency band can be provided at positions close to the center point of the plate-shaped member. Therefore, for example, even if an obstacle for RF signals is provided around the plate-shaped member, RF signals in a high frequency band, which are generally less likely to diffract, can be received with higher sensitivity.

Preferably, a plurality of antennas included in the plurality of antennas provided on the plate-shaped member constitute a second diversity antenna configured to receive RF signals in a second frequency band that is higher than the first frequency band, and at least two antennas included in the plurality of antennas that constitute the second diversity antenna are respectively provided in two regions that are not adjacent to each other when the flat surface of the plate-shaped member is divided into quadrants around the center point of the flat surface.

With such a configuration, RF signals in two frequency bands can be received with higher sensitivity, using a diversity antenna.

Preferably, the plurality of antennas that constitute the first diversity antenna are configured to receive RF signals in a frequency band for 5^{th} generation mobile communication services below 6 GHz or in frequency bands for mobile communication services of generations prior to the 5^{th} generation mobile communication services.

With such a configuration, RF signals in the frequency band for 5^{th} generation mobile communication services below 6 GHz or in the frequency bands for mobile communication services of generations prior to the 5^{th} generation mobile communication services, which are generally transmitted from a distant base station and are incident to the onboard antenna module from a direction corresponding to a small elevation angle, can be received with higher sensitivity.

An onboard antenna module according to the present disclosure includes: a plate-shaped member that is fixed to a body of a vehicle and at least a portion of which is plate-shaped; and a plurality of antennas that are provided on the plate-shaped member, wherein the plurality of antennas are provided in an opening in a roof panel of a vehicle in a plan view, a plurality of antennas included in the plurality of antennas constitute a first diversity antenna configured to receive RF signals in a first frequency band, and at least two antennas included in the plurality of antennas that constitute the first diversity antenna are respectively provided in two regions that are not adjacent to each other when the opening is divided into quadrants around a center point of the opening in a plan view.

As described above, with the structure in which the antennas that constitute the first diversity antenna are respectively provided in two regions that are not adjacent to each other when the opening of the roof panel is divided into quadrants in a plan view, a plurality of antennas including the antennas arranged at desired positions on the plate-shaped member in advance can be mounted on the vehicle all at once. Therefore, for example, compared to a case where the antennas are individually arranged on the vehicle, the antennas can be more precisely mounted on the vehicle so that the distance therebetween is as designed. Furthermore, the distance between the two antennas that constitute the first diversity antenna can be secured in a limited arrangement space on the plate-shaped member, and the degree of correlation between the two antennas can be lowered. Therefore, RF signals can be received with higher sensitivity.

Hereinafter, embodiments of the present disclosure will be described with reference to the drawings. Note that, in the drawings, the same reference numerals are given to the same or corresponding components in the drawings, and redundant descriptions thereof are not repeated. Furthermore, at least parts of the embodiments described below may be suitably combined.

### Configurations and Basic Operations

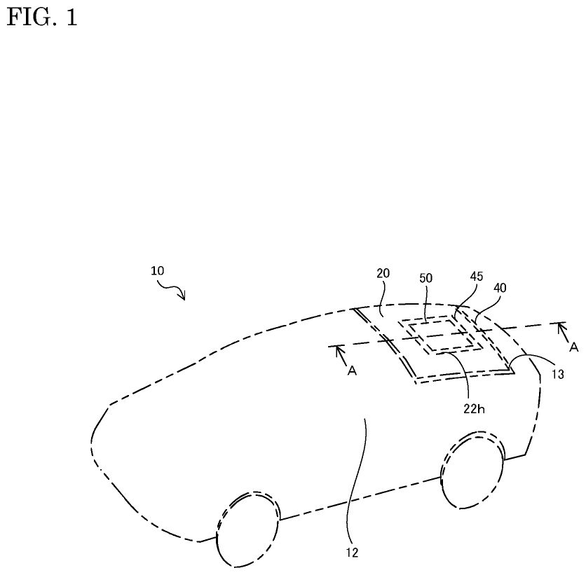

FIG. 1 is a schematic perspective view showing a vehicle according to an embodiment of the present disclosure. As shown in FIG. 1, a vehicle 10 is provided with a body 12 and a roof panel module 20.

The body 12 is a part with which the outer shape of the vehicle 10 is formed. The body 12 may be a monocoque body or a body mounted on a ladder frame. The body 12 is made from a metal plate, for example. The body 12 is provided with an opening 13 in the roof portion of the vehicle 10. The opening 13 has a rectangular shape, for example. The roof panel module 20 is fitted into the opening 13 in the body 12.

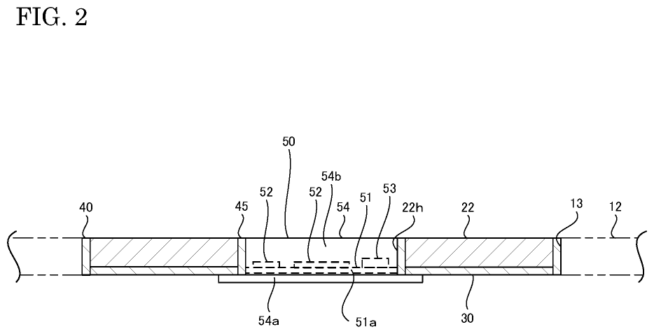

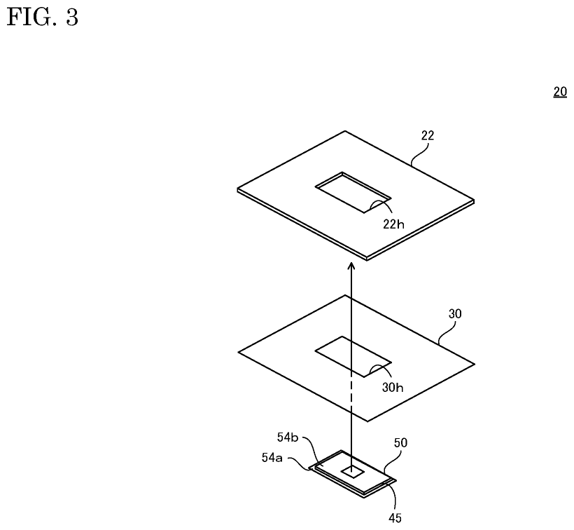

FIG. 2 is a cross-sectional view showing a roof panel module according to an embodiment of the present disclosure. FIG. 2 is a cross-sectional view taken along the line A-A in FIG. 1. FIG. 3 is an exploded perspective view showing the roof panel module according to the embodiment of the present disclosure. As shown in FIGS. 2 and 3, the roof panel module 20 includes a vehicle roof panel 22, a radio wave shielding portion 30, conductive elastic members 40 and 45, and an onboard antenna module 50.

### Vehicle Roof Panel

For example, the vehicle roof panel 22 is made of resin. The vehicle roof panel 22 has a rectangular plate shape. More specifically, the vehicle roof panel 22 has a shape corresponding to the shape of the opening 13 so as to be able to close the opening 13 in the body 12. The vehicle roof panel 22 is fixed to the body 12, using screws, for example, in the state of being fitted into the opening 13.

The vehicle roof panel 22 is provided with an antenna opening 22h that has a rectangular shape in a central portion thereof in a plan view. The onboard antenna module 50 is fitted into the antenna opening 22h. The antenna opening 22h is an example of an opening.

### Radio Wave Shielding Portion

The radio wave shielding portion 30 is fixed to a vehicle interior-side surface of the vehicle roof panel 22. The radio wave shielding portion 30 has a rectangular plate shape. For example, the radio wave shielding portion 30 has the same shape as the vehicle roof panel 22 in a plan view so as to be able to cover the entire vehicle interior-side surface of the vehicle roof panel 22. Note that the main surface of the radio wave shielding portion 30 may be larger or smaller than the vehicle interior-side surface of the vehicle roof panel 22.

The radio wave shielding portion 30 is provided with an antenna opening 30h that has a rectangular shape in a central portion thereof in a plan view. More specifically, the radio wave shielding portion 30 is provided with an antenna opening 30h at a position where the radio wave shielding portion 30 overlaps the antenna opening 22h when fixed to the vehicle interior-side surface of the vehicle roof panel 22. The onboard antenna module 50 is fitted into the antenna opening 30h.

The radio wave shielding portion 30 has the property of shielding radio waves. More specifically, the radio wave shielding portion 30 has the property of shielding radio waves in a certain frequency band. For example, the radio wave shielding portion 30 is made from a frequency selective surface (FSS). The frequency selective surface includes a base film that is made of resin or the like, and unit cells that are formed on the base film, using metal foil or the like. The frequency selective surface has the property of shielding radio waves in one or more frequency bands and transmitting radio waves in other frequency bands according to the frequency characteristics of the unit cells.

For example, the radio wave shielding portion 30 has the property of shielding radio waves of the frequencies for communication between a plurality of devices in the interior of the vehicle 10, such as smartphones, mobile phones, and personal computers. Specifically, the radio wave shielding portion 30 has the property of shielding radio waves in the frequency bands for Wi-Fi (registered trademark) communication and Bluetooth (registered trademark) communication. Alternatively, the radio wave shielding portion 30 has the property of shielding radio waves of the frequencies used to perform contactless power supply to devices in the vehicle interior. With such a configuration, it is possible to prevent radio waves output by devices in the vehicle interior from propagating to the outside of the vehicle.

Note that the radio wave shielding portion 30 may have the property of shielding radio waves of all frequencies. If this is the case, the radio wave shielding portion 30 is made of metal such as aluminum or iron. In addition, the radio wave shielding portion 30 may include a sheet-shaped member that has the property of insulating heat, sound, and so on.

### Conductive Elastic Members

The conductive elastic members 40 and 45 are conductive and elastic. For example, the conductive elastic members 40 and 45 are made of rubber that contains a conductive filler such as a conductive carbon or a metal powder.

The conductive elastic members 40 and 45 are provided along the edges of the vehicle roof panel 22.

The conductive elastic member 40 is provided along the outer peripheral edge of the vehicle roof panel 22. More specifically, the conductive elastic member 40 is provided between the outer peripheral edge of the vehicle roof panel 22 and the edge of the opening 13 of the vehicle 10. For example, the conductive elastic member 40 is fixed between the outer peripheral edge of the vehicle roof panel 22 and the edge of the opening 13 by being sandwiched therebetween.

The conductive elastic member 45 is provided along the edge of the antenna opening 22h of the vehicle roof panel 22. More specifically, the conductive elastic member 40 is provided between the edges of the antenna opening 22h and the antenna opening 30h and the outer peripheral surface of the onboard antenna module 50. For example, the conductive elastic member 45 is fixed between the edges of the antenna opening 22h and the antenna opening 30h and the outer peripheral surface of the onboard antenna module 50 by being sandwiched therebetween.

### Onboard Antenna Module

The onboard antenna module 50 includes a plate-shaped member 51, a plurality of antennas 52, a circuit unit 53, and a case 54.

At least a portion of the plate-shaped member 51 is formed in a plate-like shape. The plate-shaped member 51 has a rectangular plate shape, for example. A conductor layer 51a that serves as a ground is formed on one main surface of the plate-shaped member 51, which is the vehicle interior-side surface, for example, using a metal foil or the like. The conductor layer 51a has the property of shielding radio waves.

The antennas 52 and the circuit unit 53 are provided on the plate-shaped member 51. For example, the antennas 52 and the circuit unit 53 are provided on the vehicle exterior-side surface of the plate-shaped member 51. The arrangement of the antennas 52 and the circuit unit 53 on the plate-shaped member 51 will be described later.

The case 54 is made of resin, for example. The case 54 covers the top, bottom, and peripheral surfaces of the plate-shaped member 51 and the antennas 52. More specifically, the case 54 includes a plate-shaped bottom portion 54a and a main body portion 54b that has a parallel piped external shape. The plate-shaped member 51 is fixed to the vehicle exterior-side surface of the bottom portion 54a. The main body portion 54b is fixed to the bottom portion 54a so as to cover the plate-shaped member 51 in a state where the plate-shaped member 51 is fixed to the bottom portion 54a. In a plan view, the bottom portion 54a protrudes outward compared to the main body portion 54b in a state where the main body portion 54b is fixed to the bottom portion 54a.

For example, the antenna opening 30h in the radio wave shielding portion 30 and the antenna opening 22h in the vehicle roof panel 22 have substantially the same shape as the main body portion 54b included in the case 54 of the onboard antenna module 50 in a plan view, and are smaller than the bottom portion 54a included in the case 54.

The roof panel module 20 is formed by fitting the main body portion 54b included in the case 54 of the onboard antenna module 50 into the antenna opening 30h and the antenna opening 22h from the vehicle interior side. More specifically, the onboard antenna module 50 is fixed to the radio wave shielding portion 30 in the state of being fitted into the antenna opening 30h in the radio wave shielding portion 30. For example, the conductive elastic member 45 is provided on the outer peripheral surface of the main body portion 54b included in the case 54 of the onboard antenna module 50. A frame-shaped bracket is fixed to an outer peripheral portion of the case 54 using screws or the like. In addition, the edge of the antenna opening 30h in the radio wave shielding portion 30 is sandwiched between the outer peripheral portion of the case 54 and the bracket.

The onboard antenna module 50 is fitted into and fixed to the antenna opening 22h in the vehicle roof panel 22. More specifically, the main body portion 54b of the case 54 of the onboard antenna module 50 and the conductive elastic member 45 are fitted into the antenna opening 22h, and the radio wave shielding portion 30 is fixed to the vehicle interior-side surface of the vehicle roof panel 22. The roof panel module 20 thus formed is fixed to the body 12 by screwing the vehicle roof panel 22 to the body 12.

The plate-shaped member 51 is fixed to the body 12 of the vehicle 10. More specifically, the roof panel module 20 is fixed to the body 12 by screwing the vehicle roof panel 22 to the body 12 in a state where the plate-shaped member 51 is fixed to the bottom portion 54a of the case 54.

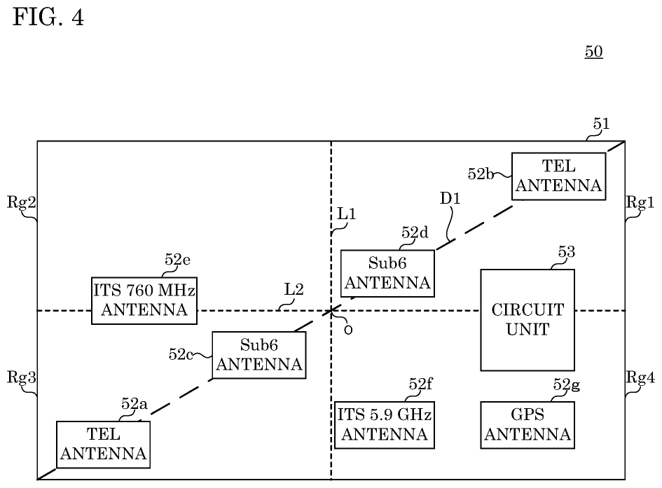

FIG. 4 is a plan view showing an example of a configuration of the onboard antenna module according to the embodiment of the present disclosure. As shown in FIG. 4, the onboard antenna module 50 includes antennas 52a, 52b, 52c, 52d, 52e, 52f, and 52g as the antennas 52. Each antenna 52 is connected to the circuit unit 53 via a transmission line (not shown). The antennas 52 are provided in the antenna opening 22h of the vehicle roof panel 22 in a plan view. For example, the antennas 52 and the circuit unit 53 are provided on the vehicle exterior-side surface of the plate-shaped member 51.

Here, various communication services are assigned to different frequency bands in various countries including Japan. For example, AM radio services are assigned to the frequency band of 526.5 kHz to 1606.5 kHz, FM radio services are assigned to the frequency band of 76 MHz to 108 MHz, TV broadcasting services are assigned to the frequency band of 470 MHz to 710 MHz, satellite radio services are assigned to the frequency band of 2.3 GHz, keyless entry services are assigned to the frequency bands of 315 MHz and 433 MHz, GPS (Global Positioning System) services are assigned to the frequency band of 1.5 GHz, 5^{th} generation mobile communication services are assigned to the frequency band of 3.5 GHz below 6 GHz, 5^{th} generation mobile communication services in the millimeter wave band are assigned to the frequency band of 28 GHz, remote control engine starter services are assigned to the frequency band of 920 MHz, 4^{th} generation mobile communication services, which are of generations of mobile communication services prior to the 5^{th} generation mobile communication services, are assigned to the frequency bands of 0.8 GHz, 1.5 GHz, 1.7 GHz, and 2 GHz, ITS (Intelligent Transport Systems) radio services are assigned to the frequency bands of 760 MHz and 5.9 GHz, and ETC (Electronic Toll Collection System) services are assigned to the frequency band of 5.8 GHz. Hereinafter, the frequency band for the 5^{th} generation mobile communication services below 6 GHz are also referred to as “Sub6”, and mobile communication services of generations prior to the 5^{th} generation mobile communication services are also referred to as “TEL”.

The antennas 52 are provided corresponding to different communication services. Each antenna 52 is capable of receiving RF signals in the frequency band to which the communication service corresponding thereto is assigned. For example, the antennas 52a and 52b correspond to the TEL, the antennas 52c and 52d correspond to the Sub6, the antenna 52e corresponds to the ITS radio service in the 760 MHz band, the antenna 52f corresponds to the ITS radio service in the 5.9 GHz band, and the antenna 52g corresponds to the GPS service.

Hereinafter, the antenna 52a is also referred to as the TEL antenna 52a, the antenna 52b is also referred to as the TEL antenna 52b, the antenna 52c is also referred to as the Sub6 antenna 52c, the antenna 52d is also referred to as the Sub6 antenna 52d, the antenna 52e is also referred to as the ITS 760 MHz antenna 52e, the antenna 52f is also referred to as the ITS 5.9 GHz antenna 52f, and the antenna 52g is also referred to as the GPS antenna 52g.

The circuit unit 53 transmits the RF signals received by the antennas 52 to onboard devices (not shown) respectively provided for various communication services in the vehicle 10, for example.

Some antennas included in the antennas 52 constitute diversity antennas that receive RF signals in the same frequency band. For example, the TEL antenna 52a and the TEL antenna 52b constitute a diversity antenna that receives RF signals in the TEL 2 GHz band. Also, for example, the Sub6 antenna 52c and the Sub6 antenna 52d constitutes a diversity antenna that receives RF signals in the Sub6 3.5 GHz band. The diversity antenna constituted by the TEL antenna 52a and the TEL antenna 52b is an example of the first diversity antenna. The diversity antenna constituted by the Sub6 antenna 52c and the Sub6 antenna 52d is an example of the second diversity antenna.

The frequency band of the RF signals received by the Sub6 antenna 52c and the Sub6 antenna 52d, i.e., the 3.5 GHz band, is higher than the frequency band of the RF signals received by the TEL antenna 52a and the TEL antenna 52b, i.e., the 2 GHz band.

The RF signals received by the diversity antennas are selectively transmitted by the circuit unit 53 to onboard devices. More specifically, when a signal strength g1 of an RF signal s1 received by an antenna included in a diversity antenna is greater than a predetermined value, the circuit unit 53 selects the RF signal s1 and transmits the RF signal s1 to the onboard device corresponding thereto. In contrast, when the signal strength g1 is less than or equal to the aforementioned predetermined value and a signal strength g2 of an RF signal s2 received by another antenna included in the diversity antenna is greater than the aforementioned predetermined value, the circuit unit 53 selects the RF signal s2 and transmits the RF signal s2 to the onboard device corresponding thereto. In contrast, when the signal strengths of the RF signals received by the plurality of antennas that constitute the diversity antenna are less than or equal to the aforementioned predetermined value, the circuit unit 53 selects the RF signal with the highest signal strength among the RF signals received by the plurality of antennas that constitute the diversity antenna, and transmits the selected RF signal to the onboard device corresponding thereto.

The TEL antenna 52a and the TEL antenna 52b are respectively provided in two regions that are not adjacent to each other when a flat surface of the plate-shaped member 51 is divided into quadrants around a center point O of the flat surface. Also, the TEL antenna 52a and the TEL antenna 52b are respectively provided in two regions that are not adjacent to each other when the antenna opening 22h is divided into quadrants around the center point of the antenna opening 22h in a plan view. More specifically, the TEL antenna 52a and the TEL antenna 52b are respectively provided in regions Rg3 and Rg1 that are not adjacent to each other when the flat surface of the plate-shaped member 51 is divided by straight lines L1 and L2 that pass through the center point O and are orthogonal to each other. For example, the straight line L1 is parallel to a first side of the rectangular plate-shaped member 51, and the straight line L2 is parallel to a second side of the rectangular plate-shaped member 51. For example, the straight line L1 is parallel to a first side of the rectangular antenna opening 22h, and the straight line L2 is parallel to a second side of the rectangular antenna opening 22h.

For example, the TEL antenna 52a and the TEL antenna 52b are provided at positions on a diagonal line D1 of the plate-shaped member 51. Specifically, for example, the center point of the TEL antenna 52a and the center point of the TEL antenna 52b are present on the diagonal line D1 of the plate-shaped member 51. Also, for example, the TEL antenna 52a and the TEL antenna 52b are provided on corner portions that are opposite to each other in the vehicle exterior-side surface of the plate-shaped member 51 so that the distance from each other is the largest on the plate-shaped member 51.

The Sub6 antenna 52c and the Sub6 antenna 52d are respectively provided in two regions that are not adjacent to each other when a flat surface of the plate-shaped member 51 is divided into quadrants around the center point O of the flat surface. Also, the Sub6 antenna 52c and the Sub6 antenna 52d are respectively provided in two regions that are not adjacent to each other when the antenna opening 22h is divided into quadrants around the center point of the antenna opening 22h in a plan view. More specifically, the Sub6 antenna 52c and the Sub6 antenna 52d are respectively provided in the regions Rg3 and Rg1 that are not adjacent to each other when the flat surface of the plate-shaped member 51 is divided by the straight lines L1 and L2.

For example, the Sub6 antenna 52c and the Sub6 antenna 52d are provided at positions on the diagonal line D1 of the plate-shaped member 51. Specifically, for example, the center point of the Sub6 antenna 52c and the center point of the Sub6 antenna 52d are present on the diagonal line D1 of the plate-shaped member 51.

For example, the TEL antenna 52a and the TEL antenna 52b are provided on the plate-shaped member 51 so as to sandwich antennas 52 that receive RF signals in a frequency band that is higher than the 2 GHz band. In the example shown in the figure, the TEL antenna 52a and the TEL antenna 52b are provided on the plate-shaped member 51 so as to sandwich the Sub6 antenna 52c and the Sub6 antenna 52d.

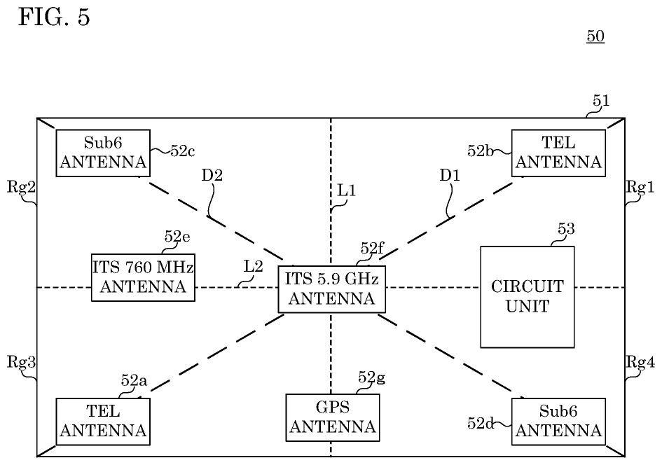

FIG. 5 is a plan view showing another example of the configuration of the onboard antenna module according to the embodiment of the present disclosure. As shown in FIG. 5, the TEL antenna 52a and the TEL antenna 52b are respectively provided in the regions Rg3 and Rg1 that are not adjacent to each other when the flat surface of the plate-shaped member 51 is divided by the straight lines L1 and L2. For example, the TEL antenna 52a and the TEL antenna 52b are provided at positions on the diagonal line D1 of the plate-shaped member 51. Also, the Sub6 antenna 52c and the Sub6 antenna 52d are respectively provided in regions Rg2 and Rg4 that are not adjacent to each other when the flat surface of the plate-shaped member 51 is divided by the straight lines L1 and L2. For example, the Sub6 antenna 52c and the Sub6 antenna 52d are provided at positions on a diagonal line D2 of the plate-shaped member 51. Specifically, for example, the center point of the Sub6 antenna 52c and the center point of the Sub6 antenna 52d are present on the diagonal line D2 of the plate-shaped member 51. Also, for example, the Sub6 antenna 52c and the Sub6 antenna 52d are provided on corner portions that are opposite to each other in the vehicle exterior-side surface of the plate-shaped member 51 so that the distance from each other is the largest on the plate-shaped member 51.

For example, the TEL antenna 52a and the TEL antenna 52b are provided on the plate-shaped member 51 so as to sandwich antennas 52 that receive RF signals in a frequency band that is higher than the 2 GHz band. In the example shown in FIG. 5, the TEL antenna 52a and the TEL antenna 52b are provided at positions on the diagonal line D1 of the plate-shaped member 51 so as to sandwich the ITS 5.9 GHz antenna 52f. Also, in the example shown in FIG. 5, the Sub6 antenna 52c and the Sub6 antenna 52d are provided at positions on the diagonal line D2 different from the diagonal line D1 of the plate-shaped member 51 so as to sandwich the ITS 5.9 GHz antenna 52f.

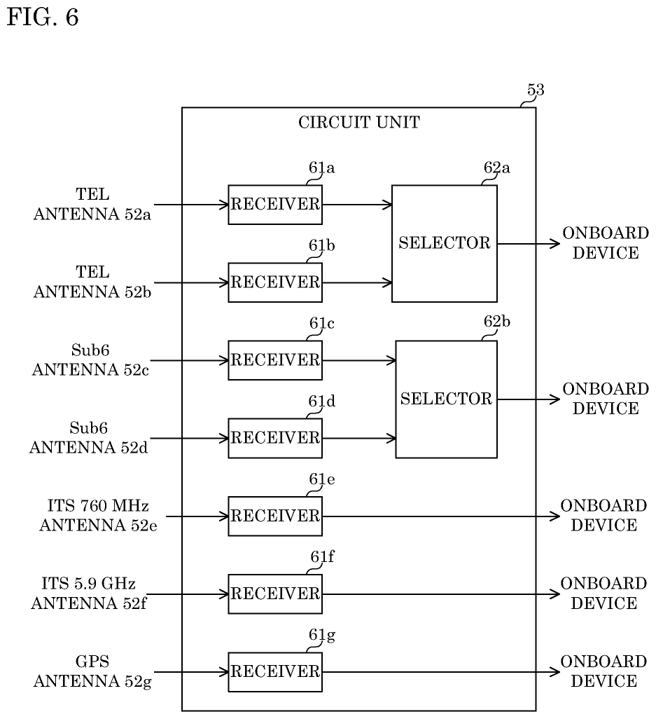

FIG. 6 is a diagram showing an example of a configuration of the circuit unit according to the embodiment of the present disclosure. As shown in FIG. 6, the circuit unit 53 includes receivers 61a, 61b, 61c, 61d, 61e, 61f, and 61g and selectors 62a and 62b. Hereinafter, each of the receivers 61a, 61b, 61c, 61d, 61e, 61f, and 61g is also referred to as a receiver 61, and each of the selectors 62a and 62b is also referred to as a selector 62.

Each of the receivers 61 is connected to the antenna 52 corresponding thereto. More specifically, the receiver 61a is connected to the TEL antenna 52a, the receiver 61b is connected to the TEL antenna 52b, the receiver 61c is connected to the Sub6 antenna 52c, the receiver 61d is connected to the Sub6 antenna 52d, the receiver 61e is connected to the ITS 760 MHz antenna 52e, the receiver 61f is connected to the ITS 5.9 GHz antenna 52f, and the receiver 61g is connected to the GPS antenna 52g.

For example, each receiver 61 includes a bandpass filter and an amplifier circuit, and filters and amplifies RF signals received by the antenna 52 corresponding thereto. The receivers 61a and 61b output the amplified RF signals to the selector 62a. The receivers 61c and 61d output the amplified RF signals to the selector 62b. Each of the receivers 61e, 61f, and 61g transmits the amplified RF signals to the onboard device corresponding thereto.

Each of the selectors 62 selectively transmits the RF signals received by two antennas 52 that constitute a diversity antenna, to an onboard device. More specifically, each of the selectors 62 selects either one of the RF signals received from the two receivers 61, and transmits the selected RF signal to an onboard device. Specifically, for example, when a signal strength ga of an RF signal sa received from the receiver 61a is greater than a threshold value Th1, the selector 62a selects the RF signal sa and transmits the RF signal sa to the onboard device corresponding thereto. In contrast, when the signal strength ga of the RF signal sa received from the receiver 61a is smaller than or equal to the threshold value Th1 and a signal strength gb of an RF signal sb received from the receiver 61b is greater than the threshold value Th1, the selector 62a selects the RF signal sb and transmits the RF signal sb to the onboard device corresponding thereto. In contrast, when the signal strength ga of the RF signal sa is smaller than or equal to the threshold value Th1 and the signal strength gb of the RF signal sb is smaller than or equal to the threshold value Th1, the selector 62a selects the RF signal with a higher signal strength of the RF signal sa and the RF signal sb, and transmits the selected RF signal to the onboard device corresponding thereto.

Also, for example, when a signal strength gc of an RF signal sc received from the receiver 61c is greater than a threshold value Th2, the selector 62b selects the RF signal sc and transmits the RF signal sc to the onboard device corresponding thereto. In contrast, when the signal strength gc of the RF signal sc received from the receiver 61c is smaller than or equal to the threshold value Th2 and a signal strength gd of an RF signal sd received from the receiver 61d is greater than the threshold value Th2, the selector 62b selects the RF signal sd and transmits the RF signal sd to the onboard device corresponding thereto. In contrast, when the signal strength gc of the RF signal sc is smaller than or equal to the threshold value Th2 and the signal strength gd of the RF signal sd is smaller than or equal to the threshold value Th2, the selector 62b selects the RF signal with a higher signal strength of the RF signal sc and the RF signal sd, and transmits the selected RF signal to the onboard device corresponding thereto.

For example, each selector 62 includes a comparison circuit that compares the signal strength of an RF signal received from a receiver 61 corresponding thereto with a threshold value or the signal strength of an RF signal received from another receiver 61 corresponding thereto, and a switch for switching to an RF signal that is to be transmitted to the onboard device corresponding thereto, of RF signals received from two receivers 61. Each selector 62 regularly or irregularly compares the signal strength of an RF signal received from the receiver 61 corresponding thereto, with the threshold value. Thereafter, the selector 62 selects either one of the RF signals received from the two receivers 61 based on the result of the comparison, and transmits the selected RF signal to the onboard device corresponding thereto.

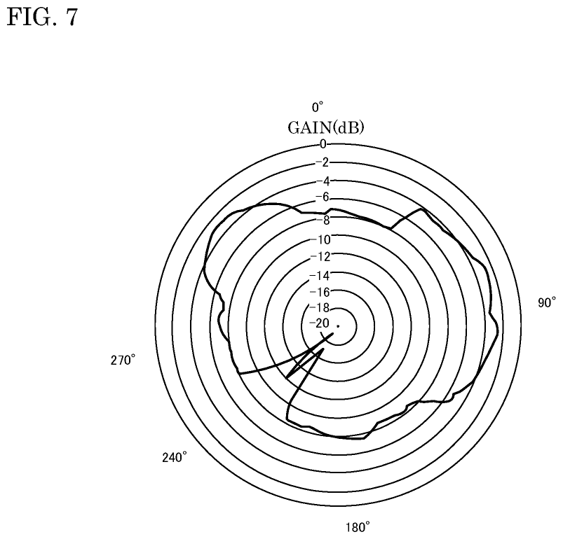

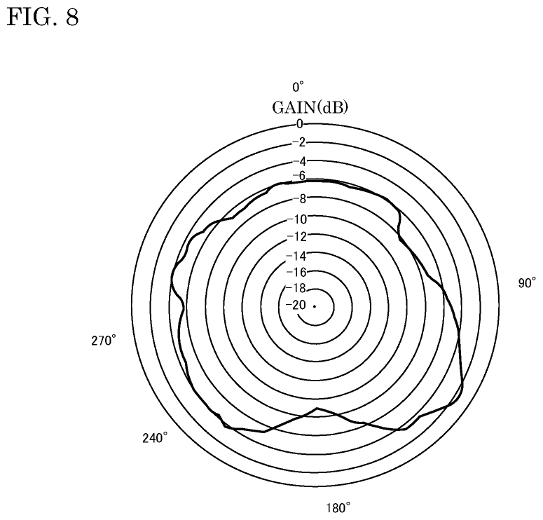

FIG. 7 is a diagram showing the directivity of an antenna according to the embodiment of the present disclosure. FIG. 7 shows the directivity of the TEL antenna 52a included in the onboard antenna module 50 shown in FIG. 4, with respect to vertically polarized RF signals incident from the direction corresponding to an elevation angle of 40°. FIG. 8 is a graph showing the directivity of an antenna according to the embodiment of the present disclosure. FIG. 8 shows the directivity of the TEL antenna 52b included in the onboard antenna module 50 shown in FIG. 4, with respect to vertically polarized RF signals incident from the direction corresponding to an elevation angle of 40°.

As shown in FIGS. 7 and 8, the TEL antenna 52a and the TEL antenna 52b each have a different directivity due to the effect of the installation position thereof on the plate-shaped member 51. Specifically, for example, the directivity of the TEL antenna 52a has a null point in the direction corresponding to an azimuth angle of approximately 240°. That is to say, the TEL antenna 52a has low receiving sensitivity with respect to RF signals incident from the direction corresponding to an azimuth angle of approximately 240°. In contrast, the TEL antenna 52b does not have a null point in the direction corresponding to an azimuth angle of approximately 240°. The receiving sensitivity of the TEL antenna 52b with respect to RF signals incident from the direction corresponding to an azimuth angle of approximately 240° is higher than the receiving sensitivity of the TEL antenna 52a with respect to RF signals incident from the direction corresponding to an azimuth angle of approximately 240°.

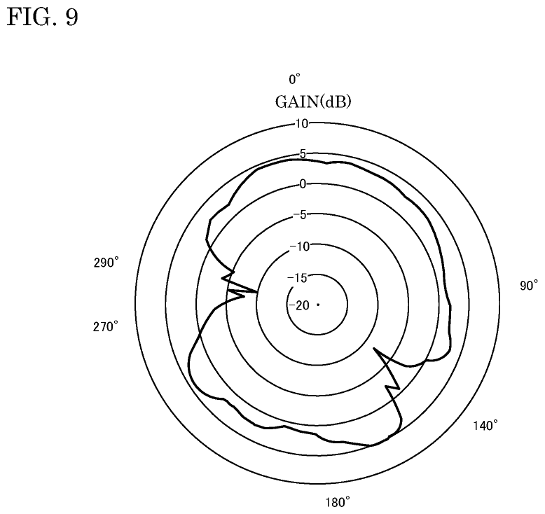

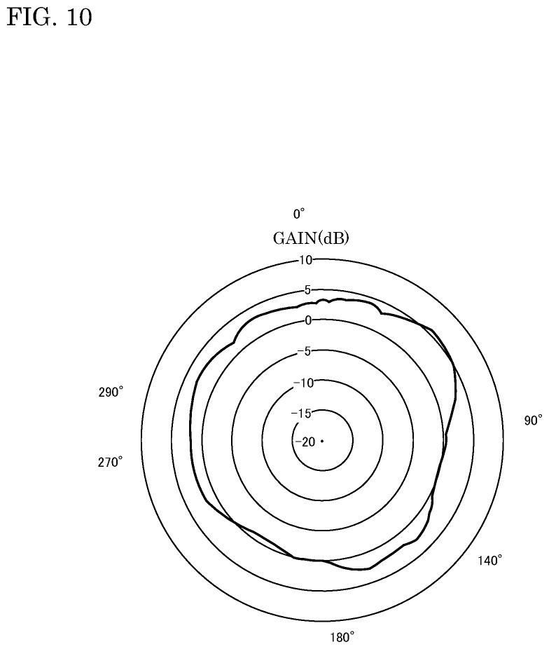

FIG. 9 is a graph showing the directivity of an antenna according to the embodiment of the present disclosure. FIG. 9 shows the directivity of the Sub6 antenna 52c included in the onboard antenna module 50 shown in FIG. 4, with respect to vertically polarized RF signals incident from the direction corresponding to an elevation angle of 40°. FIG. 10 is a graph showing the directivity of an antenna according to the embodiment of the present disclosure. FIG. 10 shows the directivity of the Sub6 antenna 52d included in the onboard antenna module 50 shown in FIG. 4, with respect to vertically polarized RF signals incident from the direction corresponding to an elevation angle of 40°.

As shown in FIGS. 9 and 10, the Sub6 antenna 52c and the Sub6 antenna 52d each have a different directivity due to the effect of the installation position thereof on the plate-shaped member 51. Specifically, for example, the directivity of the Sub6 antenna 52c has null points respectively in the direction corresponding to an azimuth angle of approximately 140° and in the direction corresponding to an azimuth angle of approximately 290°. That is to say, the Sub6 antenna 52c has low receiving sensitivity with respect to RF signals incident from the direction corresponding to an azimuth angle of approximately 140° and RF signals incident from the direction corresponding to an azimuth angle of approximately 290°. In contrast, the Sub6 antenna 52d does not have a null point in the direction corresponding to an azimuth angle of approximately 140° or in the direction corresponding to an azimuth angle of approximately 290°. The receiving sensitivity of the Sub6 antenna 52d with respect to RF signals incident from the direction corresponding to an azimuth angle of approximately 140° is higher than the receiving sensitivity of the Sub6 antenna 52c with respect to RF signals incident from the direction corresponding to an azimuth angle of approximately 140°. The receiving sensitivity of the Sub6 antenna 52d with respect to RF signals incident from the direction corresponding to an azimuth angle of approximately 290° is higher than the receiving sensitivity of the Sub6 antenna 52c with respect to RF signals incident from the direction corresponding to an azimuth angle of approximately 290°.

The signal strength ga of the RF signal sa output from the receiver 61a and the signal strength gb of the RF signal sb output from the receiver 61b may be different from each other due to the above-described difference between the directivities of the TEL antenna 52a and the TEL antenna 52b. Also, the signal strength gc of the RF signal sc output from the receiver 61c and the signal strength gd of the RF signal sd output from the receiver 61d may be different from each other due to the above-described difference between the directivities of the Sub6 antenna 52c and the Sub6 antenna 52d.

The selector 62 compares the signal strength ga of the RF signal sa received from the receiver 61a and the signal strength gb of the RF signal sb received from the receiver 61b with threshold value Th1, and transmits either the RF signal sa or the RF signal sb to the onboard device corresponding thereto, based on the result of the comparison. Also, the selector 62 compares the signal strength gc of the RF signal sc received from the receiver 61c and the signal strength gd of the RF signal sd received from the receiver 61d with threshold value Th2, and transmits either the RF signal sc or the RF signal sd to the onboard device corresponding thereto, based on the result of the comparison.

As a result, even if the signal strength of either one of the RF signals from the TEL antennas 52a and 52b decreases, it is possible to transmit the other RF signal to the onboard device corresponding thereto to prevent a decrease in the signal strength of the RF signal received by the onboard device. Also, for example, even if the signal strength of either one of the RF signals from the Sub6 antenna 52c and the Sub6 antenna 52d decreases, it is possible to transmit the other RF signal to the onboard device corresponding thereto to prevent a decrease in the signal strength of the RF signal received by the onboard device.

### Operation Flow

The onboard antenna module 50 according to the embodiment of the present disclosure includes a computer that includes a memory, and an arithmetic processing unit such as a CPU in the computer reads out a program that includes some or all of the steps of the following flowcharts and sequences from the memory, and executes the program. This program can be installed externally. This program is distributed in the state of being stored on a recording medium.

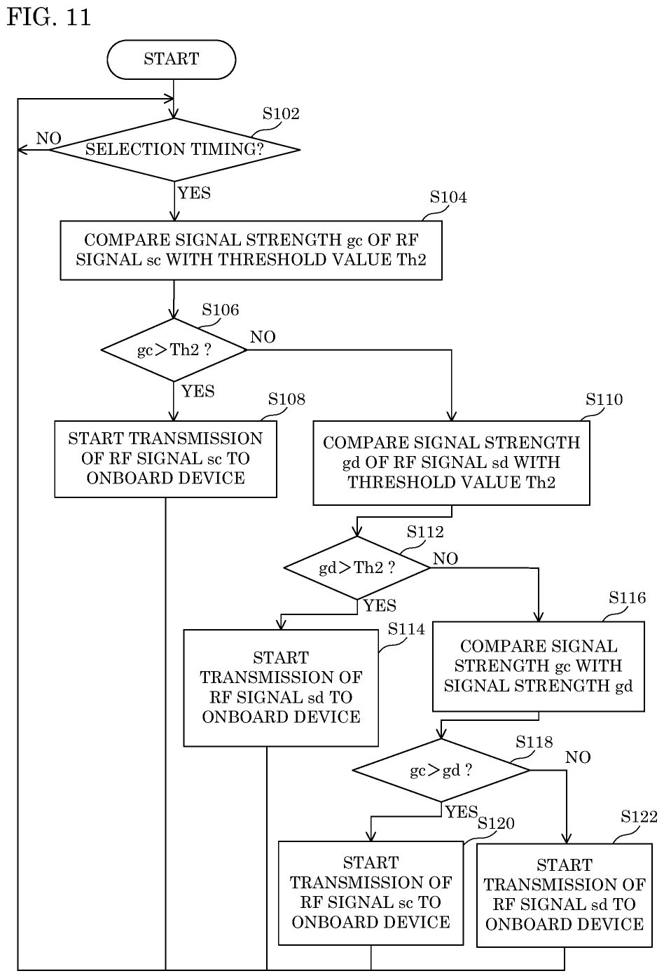

FIG. 11 is a flowchart that defines an example of an operating procedure that is performed when the circuit unit in the onboard antenna module according to the embodiment of the present disclosure selectively transmits an RF signal to an onboard device. FIG. 11 shows an operation procedure that is performed when the circuit unit 53 selects either one of the RF signals received from the receivers 51c and 51d and transmits the selected RF signal to an onboard device.

As shown in FIG. 11, first, the circuit unit 53 waits for a selection timing that follows a predetermined cycle (NO in step S102), and at the selection timing (YES in step S102), compares the signal strength gc of the RF signal sc received from the receiver 61c with the predetermined threshold value Th2 (step S104).

Next, if the signal strength gc of the RF signal sc is greater than the threshold value Th2 (YES in step S106), the circuit unit 53 sets the RF signal sc as the RF signal to be transmitted to the onboard device, and starts transmitting the RF signal sc to the onboard device (step S108). Next, the circuit unit 53 waits for a new selection timing (step S102).

On the other hand, if the signal strength gc of the RF signal sc is smaller than or equal to the threshold value Th2 (NO in step S106), the circuit unit 53 compares the signal strength gd of the RF signal sd received from the receiver 61d with the threshold value Th2 (step S110).

Next, if the signal strength gd of the RF signal sd is greater than the threshold value Th2 (YES in step S112), the circuit unit 53 sets the RF signal sd as the RF signal to be transmitted to the onboard device, and starts transmitting the RF signal sd to the onboard device (step S114). Next, the circuit unit 53 waits for a new selection timing (step S102).

On the other hand, if the signal strength gd of the RF signal sd is smaller than or equal to the threshold value Th2 (NO in step S112), the circuit unit 53 compares the signal strength gc of the RF signal sc received from the receiver 61c with the signal strength gd of the RF signal sd received from the receiver 61d (step S116).

Next, if the signal strength gc of the RF signal sc is greater than the signal strength gd of the RF signal sd (YES in step S118), the circuit unit 53 sets the RF signal sc as the RF signal to be transmitted to the onboard device, and starts transmitting the RF signal sc to the onboard device (step S120). Next, the circuit unit 53 waits for a new selection timing (step S102).

On the other hand, if the signal strength gc of the RF signal sc is smaller than or equal to the signal strength gd of the RF signal sd (NO in step S118), the circuit unit 53 sets the RF signal sd as the RF signal to be transmitted to the onboard device, and starts transmitting the RF signal sd to the onboard device (step S122). Next, the circuit unit 53 waits for a new selection timing (step S102).

Note that, in the onboard antenna module 50 according to the embodiment of the present disclosure includes the TEL antennas 52a and 52b, the Sub6 antennas 52c and 52d, the ITS 760 MHz antenna 52e, the ITS 5.9 GHz antenna 52f, and the GPS antenna 52g as antennas 52. However, the present disclosure is not limited to such a configuration. In addition to the antennas 52 corresponding to the above-described communication services, or instead of the antennas 52 corresponding to the above-described communication services, the onboard antenna module 50 may include antennas 52 corresponding to communication services other than the above-described communication services.

In the onboard antenna module 50 according to the embodiment of the present disclosure, the TEL antenna 52a and the TEL antenna 52b are provided on the plate-shaped member 51 so as to sandwich the Sub6 antenna 52c and 52d or the ITS 5.9 GHz antenna 52f. However, the present disclosure is not limited to such a configuration. The TEL antenna 52a and the TEL antenna 52b may be provided on the plate-shaped member 51 so as not to sandwich other antennas 52, or provided on the plate-shaped member 51 so as to sandwich antennas 52 other than the Sub6 antennas 52c and 52d or the ITS 5.9 GHz antenna 52f.

The onboard antenna module 50 according to the embodiment of the present disclosure includes the TEL antennas 52a and 52b that constitutes a diversity antenna and the Sub6 antennas 52c and 52d that constitute a diversity antenna. However, the present disclosure is not limited to such a configuration. The onboard antenna module 50 may include one or three or more diversity antennas.

The onboard antenna module 50 according to the embodiment of the present disclosure includes diversity antennas each of which is constituted by two antennas. However, the present disclosure is not limited to such a configuration. The onboard antenna module 50 may include diversity antennas each of which is constituted by three or more antennas.

The onboard antenna module 50 according to the embodiment of the present disclosure includes the TEL antennas 52a and 52b that receive RF signals in the TEL frequency band and the Sub6 antennas 52c and 52d that receive RF signals in the Sub6 frequency band as diversity antennas. However, the present disclosure is not limited to such a configuration. The onboard antenna module 50 may include a diversity antenna that receives RF signals in another frequency band.

In the circuit unit 53 included in the onboard antenna module 50 according to the embodiment of the present disclosure, each selector 62 is configured to selectively transmit RF signals received from two receivers 61, to an onboard device. However, the present disclosure is not limited to such a configuration. Each selector 62 may be configured to combine the RF signals received from two receivers 61 and transmit the combined signal to the onboard device.

The onboard antenna module 50 according to the embodiment of the present disclosure includes the circuit unit 53. However, the present disclosure is not limited to such a configuration. A portion or the entirety of the circuit unit 53 may be provided outside the onboard antenna module 50.

By the way, it is desirable to have a technology that enables reception of RF signals with higher sensitivity. For example, when an antenna 52 in the onboard antenna module 50 is to receive RF signals incident to the onboard antenna module 50 from a direction corresponding to a small elevation angle, the receiving sensitivity thereof with respect to RF signals incident from the direction corresponding to a certain azimuthal angle may decrease due to the effects of RF signals reflected by the body 12 of the vehicle 10. That is to say, the directivity of each antenna 52 may have a null point in the direction corresponding to a certain azimuth angle. Therefore, a diversity antenna may be used to solve such a problem. However, it is not easy to precisely arrange each of the antennas included in the diversity antenna on the vehicle 10. For example, the distances between the antennas included in the diversity antenna may deviate from the designed values.

In contrast, in the onboard antenna module 50 according to the embodiment of the present disclosure, the plate-shaped member 51 is fixed to the body 12 of the vehicle 10, and at least a portion thereof is plate-shaped. The plurality of antennas 52 are provided on the plate-shaped member 51. The TEL antennas 52a and 52b included in the plurality of antennas 52 constitute a first diversity antenna that receives RF signals in a first frequency band. The TEL antennas 52a and 52b are respectively provided in two regions that are not adjacent to each other when a flat surface of the plate-shaped member 51 is divided into quadrants around the center point of the flat surface.

As described above, with the structure in which the TEL antennas 52a and 52b that constitute the first diversity antenna are respectively provided in two regions that are not adjacent to each other when the flat surface of the plate-shaped member 51 is divided into quadrants, a plurality of antennas including the TEL antennas 52a and 52b arranged at desired positions on the plate-shaped member 51 in advance can be mounted on the vehicle 10 all at once. Therefore, for example, compared to a case where the TEL antennas 52a and 52b are individually arranged on the vehicle 10, the TEL antennas 52a and 52b can be more precisely mounted on the vehicle 10 so that the distance therebetween is as designed. Furthermore, the distance between the TEL antennas 52a and 52b can be secured in a limited arrangement space on the plate-shaped member 51, and the degree of correlation between the TEL antennas 52a and 52b can be lowered.

Also, in the onboard antenna module 50 according to the embodiment of the present disclosure, the plate-shaped member 51 is fixed to the body 12 of the vehicle 10, and at least a portion thereof is plate-shaped. The plurality of antennas 52 are provided on the plate-shaped member 51. The plurality of antennas 52 are provided in the antenna opening 22h of the vehicle roof panel 22 in a plan view. The TEL antennas 52a and 52b included in the plurality of antennas 52 constitute a first diversity antenna that receives RF signals in a first frequency band. The TEL antennas 52a and 52b are respectively provided in two regions that are not adjacent to each other when the antenna opening 22h is divided into quadrants around the center point of the antenna opening 22h in a plan view.

As described above, with the structure in which the TEL antennas 52a and 52b that constitute the first diversity antenna are respectively provided in two regions that are not adjacent to each other when the antenna opening 22h is divided into quadrants in a plan view, a plurality of antennas including the TEL antennas 52a and 52b provided at desired positions on the plate-shaped member 51 in advance can be mounted on the vehicle 10 all at once. Therefore, for example, compared to a case where the TEL antennas 52a and 52b are individually positioned on the vehicle 10, the TEL antennas 52a and 52b can be more precisely mounted on the vehicle 10 so that the distance therebetween is as designed. Furthermore, the distance between the TEL antennas 52a and 52b can be secured in a limited arrangement space on the plate-shaped member 51, and the degree of correlation between the TEL antennas 52a and 52b can be lowered. Therefore, RF signals can be received with higher sensitivity.

Therefore, with the onboard antenna module 50 according to the embodiment of the present disclosure, RF signals can be received with higher sensitivity.

The foregoing embodiments are to be construed in all respects as illustrative and not restrictive. The scope of the present disclosure is defined by the claims rather than the description above, and is intended to include all modifications within the meaning and scope of the claims and equivalents thereof.

The above description includes the features described in the following supplementary note.

### SUPPLEMENTARY NOTE 1

An onboard antenna module including:

a plate-shaped member that is fixed to a body of a vehicle and at least a portion of which is plate-shaped; and

a plurality of antennas that are provided on the plate-shaped member,

wherein a plurality of antennas included in the plurality of antennas provided on the plate-shaped member constitute a first diversity antenna configured to receive RF signals in a first frequency band,

at least two antennas included in the plurality of antennas that constitute the first diversity antenna are respectively provided in two regions that are not adjacent to each other when a flat surface of the plate-shaped member is divided into quadrants,

the plate-shaped member has a rectangular shape, and

at least two antennas included in the plurality of antennas that constitute the first diversity antenna are provided on corner portions that are opposite to each other in one surface of the plate-shaped member.

1. An onboard antenna module comprising:
a plate-shaped member that is fixed to a body of a vehicle and at least a portion of which is plate-shaped; and
a plurality of antennas that are provided on the plate-shaped member,
wherein a plurality of antennas included in the plurality of antennas provided on the plate-shaped member constitute a first diversity antenna configured to receive RF (Radio Frequency) signals in a first frequency band, and
at least two antennas included in the plurality of antennas that constitute the first diversity antenna are respectively provided in two regions that are not adjacent to each other when a flat surface of the plate-shaped member is divided into quadrants around a center point of the flat surface.

2. The onboard antenna module according to claim 1, wherein the two antennas included in the plurality of antennas that constitute the first diversity antenna are provided on the plate-shaped member so as to sandwich other antennas configured to receive RF signals in a frequency band that is higher than the first frequency band.

3. The onboard antenna module according to claim 1,
wherein a plurality of antennas included in the plurality of antennas provided on the plate-shaped member constitute a second diversity antenna configured to receive RF signals in a second frequency band that is higher than the first frequency band, and
at least two antennas included in the plurality of antennas that constitute the second diversity antenna are respectively provided in two regions that are not adjacent to each other when the flat surface of the plate-shaped member is divided into quadrants around the center point of the flat surface.

4. The onboard antenna module according claim 1, wherein the plurality of antennas that constitute the first diversity antenna are configured to receive RF signals in a frequency band for 5^{th} generation mobile communication services below 6 GHz or in frequency bands for mobile communication services of generations prior to the 5^{th} generation mobile communication services.

5. An onboard antenna module comprising:
a plate-shaped member that is fixed to a body of a vehicle and at least a portion of which is plate-shaped; and
a plurality of antennas that are provided on the plate-shaped member,
wherein the plurality of antennas are provided in an opening in a roof panel of a vehicle in a plan view,
a plurality of antennas included in the plurality of antennas constitute a first diversity antenna configured to receive RF signals in a first frequency band, and
at least two antennas included in the plurality of antennas that constitute the first diversity antenna are respectively provided in two regions that are not adjacent to each other when the opening is divided into quadrants around a center point of the opening in a plan view.
